(19) United States
(12) Patent Application Publication
(10) Pub. No.: US 2018/0118934 A1
(43) Pub. Date: May 3, 2018

(54) METHOD FOR THE RUBBER MODIFICATION OF THERMOSETTING RESINS

(71) Applicant: BASF SE, Ludwigshfen (DE)

(72) Inventors: MARTIN WEBER, Maikammer (DE); Christian MALETZKO, Altrip (DE); Florian HENNENBERGER, Heppenheim (DE); Axel WILMS, Frankenthal (DE)

(21) Appl. No.: 15/566,459

(22) PCT Filed: Apr. 13, 2016
(86) PCT No.: PCT/EP2016/058131

§ 371 Date: Oct. 13, 2017

(30) Foreign Application Priority Data
Apr. 14, 2015 (EP) 15163555.4

(51) Int. Cl. C08L 63/00; C08G 59/42; C08G 59/24; B29C 67/24

(52) U.S. Cl. CPC C08L 63/00; C08G 59/4238; B29K 2063/00; B29C 67/24; C08L 2205/06; C08G 59/245

(57) ABSTRACT

The present invention relates to a process for producing thermoset moldings, to the thermoset moldings themselves, to the use of the thermoset moldings as components and to the use of a thermoplastic polymer having a porosity in the range from 10% to 90% for increasing the toughness of a thermoset.

The present invention relates to a process for producing thermoset moldings, to the thermoset moldings themselves, to the use of the thermoset moldings as components and to the use of a thermoplastic polymer having a porosity in the range from 10% to 90% for increasing the toughness of a thermoset.

Thermoset moldings based on thermosettably crosslinkable resin systems and processes for production thereof are known per se. The thermoset moldings frequently comprise reinforcing materials such as fibers, fabrics or scrims, in which case the thermoset forms the matrix. Thermoset moldings feature excellent material properties, with a distinct reduction in density compared to metals. Thermoset moldings feature high stiffness which is independent of temperature over wide ranges. A further advantage of thermoset moldings is the high hardness and good thermal, chemical, weathering and heat distortion stability thereof. Thermoset moldings therefore find widespread use, for example in electrical engineering, in the aerospace industry, in the construction of wind power plants, and in the construction industry.

A significant disadvantage of thermoset moldings is the comparatively low toughness thereof, which is a consequence of the high crosslinking density.

To increase the toughness, especially to increase the impact resistance, EP 1 446 452 B1 describes the use of thermoplastic polyarylene ether sulfones.

EP 1 446 452 B1 describes the improvement of impact resistance of a thermosettably crosslinkable epoxy resin system. This thermoset epoxy resin system is formed from an at least bifunctional epoxy compound, a hardener and a hardening accelerator. Thermoplastics used include polyarylene ether sulfones. The thermoplastic polyarylene ether sulfone is introduced as follows: the epoxy compound and the hardener are initially charged and heated. Subsequently, the thermoplastic polyarylene ether sulfone is added to the mixture of epoxy compound and hardener. Then the mixture is stirred while heating until the thermoplastic polyarylene ether sulfone has dissolved completely in the mixture of epoxy compound and hardener. Thereafter, the hardening accelerator is added.

A disadvantage of this process is the time-consuming dissolution of the thermoplastic polyarylene ether sulfone. Furthermore, the thermoplastic polyarylene ether sulfone is exposed to thermal stress during the dissolution, which can lead to a deterioration in the intrinsic color. In the process according to EP 1 446 452 B1, a distinct increase in viscosity can additionally already occur prior to the injection of the thermosettably curable epoxy resin system into the mold, which makes it difficult to introduce the thermosettably curable epoxy resin system into the mold.

DE 601 26 345 discloses pulverulent curable resin compositions having improved heat resistance, stiffness, and toughness after the curing. The curable resin compositions comprise a thermoplastic polyarylene ether and allylic monomers as well as acryloyl monomers that can form thermosets upon curing. The thermoplastic polyarylene ether is heated in a solvent together with the allylic monomer until it is completely dissolved and subsequently the acryloyl monomer is added to the mixture which is then cooled. The cooled, hardened and wax-like solution is subsequently further cooled with liquid nitrogen, grounded and a curing catalyst is added.

Similar to the process disclosed in EP 1 446 452, the dissolution of the thermoplastic polyarylene ether in the process according to DE 601 26 345 requires a significant expenditure of time as well as high temperatures, that can deteriorate the intrinsic color of the modified thermoset.

A further means of introducing thermoplastic polymers into thermoset moldings is to provide the thermoplastic polymer in the form of a thin film and to apply this film to the reinforcing material present in the mold. Subsequently, reinforcing material and film are insert molded or infiltrated in the mold with a thermosettably crosslinkable resin system.

This process affords moldings having an imperfect intrinsic color and inadequate notched impact strength.

It is thus an object of the present invention to provide a process for producing thermoset moldings having acceptable notched impact strengths and low intrinsic color. The process is additionally to be performable in a simple and time-efficient manner. The process is to remedy the disadvantages described in the prior art, or at least have them to a reduced degree. The process is additionally to be performable in a time- and cost-efficient manner.

This object is achieved by a process for producing a thermoset molding, comprising the steps of
a) providing a thermosettably crosslinkable resin system in a mold,
b) crosslinking the thermosettably crosslinkable resin system provided in step a) in the mold in the presence of a thermoplastic polymer having a porosity of 10% to 90% to obtain the thermoset molding,
c) removing the thermoset molding from the mold.

The present invention further provides a thermoset molding obtainable by the aforementioned process.

The present invention further provides for the use of a thermoplastic polymer having a porosity of 10% to 90% for increasing the toughness of a thermoset, preferably for increasing the toughness of a thermoset molding.

“Increasing the toughness” is preferably understood in accordance with the invention to mean an increase in the notched impact strength to ISO 180.

Notched impact strength is determined on a thermoset molding (having dimensions of 80*10*2 mm and introducing a notch having a depth of 2 mm and a radius of 2.5 mm. The notch is introduced on the side having edge lengths of 80*10 mm.

The process of the invention distinctly shortens the time required for dissolution of the thermoplastic polymer. The process of the invention is thus much more time-efficient and hence performable less expensively compared to the processes described in the prior art.

The thermoset moldings obtainable by the process of the invention have low intrinsic color combined with simultaneously good notched impact strength.

### Thermosettably Crosslinkable Resin System

According to the invention, “thermosettably crosslinkable resin systems” are understood to mean resin systems which can react by a polyaddition reaction to give thermosets. In the polyaddition reaction, the components present in the thermosettably crosslinkable resin system crosslink, forming a three-dimensionally crosslinked polymer structure (thermoset). The polyaddition reaction by which the thermosettably crosslinkable resin system in the thermoset is converted is also referred to as “hardening”. The thermosettably crosslinkable resin system provided in process step a), according to the invention, is present in unhardened or only partly hardened form. The thermoset molding (thermoset) obtained in process step b) or c), according to the invention, is in hardened form, preferably fully hardened form.

According to the invention, “hardened” is understood to mean progress of the polyaddition reaction in the range from 90% to 98%. According to the invention, “fully hardened” is understood to mean progress of the polyaddition reaction in the range from >98% to 100%. According to the invention, “unhardened” is understood to mean progress of the polyaddition reaction in the range from 0% to 5%. According to the invention, “only partly hardened” is understood to mean progress of the reaction of >5% to 50%.

According to the invention, it is possible to use any of the thermosettably crosslinkable resin systems known to those skilled in the art. Suitable thermosettably crosslinkable resin systems are, for example, selected from the group consisting of thermosettably crosslinkable epoxy resin systems, thermosettably crosslinkable urea-formaldehyde resin systems, thermosettably crosslinkable melamine-formaldehyde resin systems, thermosettably crosslinkable melamine-phenol-formaldehyde resin systems, thermosettably crosslinkable phenol-formaldehyde resin systems and thermosettably crosslinkable bismaleimide resin systems.

The present invention thus also provides a process in which the thermosettably crosslinkable resin system provided in process step a) is selected from the group consisting of thermosettably crosslinkable epoxy resin systems, thermosettably crosslinkable urea-formaldehyde resin systems, thermosettably crosslinkable melamine-formaldehyde resin systems, thermosettably crosslinkable melamine-phenol-formaldehyde resin systems, thermosettably crosslinkable phenol-formaldehyde resin systems and thermosettably crosslinkable bismaleimide resin systems.

Preferably in accordance with the invention, thermosettably crosslinkable epoxy resin systems are provided in process step a). According to the invention, the thermosettably crosslinkable epoxy resin system provided with preference in process step a) is likewise in the unhardened or only partly hardened state, the aforementioned definitions and preferences applying correspondingly to the thermosettably crosslinkable resin system.

Suitable thermoset crosslinkable epoxy resin systems comprise, as component (A), at least one epoxy compound (E) having at least one epoxy group per molecule and, as component (B), at least one hardener (H).

The present invention thus also provides a process for producing a thermoset molding, in which the thermosettably crosslinkable resin system provided in process step a) is an epoxy resin system comprising the following components:
(A) at least one epoxy compound (E) having at least one epoxy group per molecule, and
(B) at least one hardener (H).

### Epoxy Compound (E)

Preferably, the epoxy compound (E) has at least two epoxy groups per molecule.

Even more preferably, the epoxy compound (E) is a bisglycidyl ether based on bisphenols of the general formula (II)

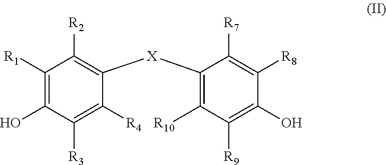

where

R¹ to R⁴ and R⁷ to R¹⁰ are each independently H, C₁-C₆-alkyl, aryl, halogen or C₂-C₁₀-alkenyl, where R¹ to R⁴ and R⁷ to R¹⁰ may also be part of a ring system;

X is CR⁵R⁶ or SO₂;
if X is CR⁵R⁶, R⁵ and R⁶ are each independently H, halogen, C₁-C₆-alkyl, C₂-C₁₀-alkenyl or aryl or R⁵ and R⁶ may also be part of a ring system. A ring system may, for example, be a cyclohexane ring.

The present invention thus also provides a process in which the epoxy compound (E) is a bisglycidyl ether based on bisphenols of the general formula (II).

Bisglycidyl ethers can be prepared by methods known to those skilled in the art proceeding from bisphenols of the general formula (II) by reaction with epichlorohydrin.

Even more preferably, the epoxy compound (E), in a further embodiment, is selected from the group of tetraglycidylmethylenedianiline (TGMDA), epoxy novolaks (the reaction products of epichlorohydrin and phenolic resins (novolak)) and cycloaliphatic epoxy resins such as 3,4-epoxycyclohexylmethyl-3,4-epoxycyclohexanecarboxylate and diglycidyl hexahydrophthalate.

Even more preferably, the epoxy compound (E), in a further embodiment, is selected from the group of dicarboxylic acids and monocarboxylic acids which additionally have a hydroxyl group and have been reacted with epichlorohydrin, such as p-hydroxybenzoic acid, beta-hydroxynaphthalic acid, polycarboxylic acids, phthalic acid, methylphthalic acid, isophthalic acid, terephthalic acid, tetrahydrophthalic acid, hexahydrophthalic acid, endomethylenetetrahydrophthalic acid, endomethylenehexahydrophthalic acid, benzene-1,2,4-tricarboxylic acid, polymerized fatty acids.

Even more preferably, the epoxy compound (E), in a further embodiment, is an epoxy resin of the glycidyl aminoglycidyl ether type, obtained from the reaction of epichlorohydrin with compounds selected from the group of aminophenol or aminomethyl-, aminoethyl-, aminopropyl-, aminobutyl- and aminoisopropylphenol, aminobenzoic acid, or a glycidylamine obtained from aniline, toluidine, tribromoanilline, xylenediamine, diaminocyclohexane, bisaminomethylcyclohexane, 4,4′-diaminodiphenylmethane, or 4,4″-diaminodiphenyl sulfone.

Especially preferably, the epoxy compound (E) is a bisglycidyl ether based on bisphenols, in which the bisphenols are selected from the group of bisphenol A (CAS: 80-05-7), bisphenol AF (CAS: 1478-61-1), bisphenol AP (CAS: 1571-75-1), bisphenol B (CAS: 77-40-7), bisphenol BP (CAS: 1844-01-5), bisphenol C (CAS: 79-97-0), bisphenol C (CAS: 14868-03-2), bisphenol E (CAS: 2081-08-5), bisphenol F (CAS: 620-92-8), bisphenol FL (CAS: 3236-71-3), bisphenol G (CAS: 127-54-8), bisphenol M (CAS: 13595-25-0), bisphenol P (CAS: 2167-51-3), bisphenol PH (CAS: 24038-68-4), bisphenol S (CAS: 80-09-1), bisphenol TMC (CAS: 129188-99-4) and bisphenol Z (CAS: 843-55-0).

In this context, for example, “bisphenol A (CAS: 80-05-7)” means bisphenol A given the CAS (Chemical Abstracts Service) number 80-05-7. By interrogating a relevant database such as “SciFinder” from the Chemical Abstracts Service or else via an Internet search, it is possible to assign the substance in question, via the number, an unambiguous chemical structure or else IUPAC name.

In the context of the present invention, definitions such as “C₁-C₆-alkyl”, as defined, for example, for the R¹ radical in formula (II), mean that this substituent is an alkyl radical having 1 to 6 carbon atoms. This may be linear, branched or cyclic. Examples of alkyl radicals are methyl, ethyl, propyl, butyl, pentyl, hexyl or cyclohexyl.

In the context of the present invention, definitions such as “C₂-C₁₀-alkenyl”, as defined, for example, for the R¹ radical in formula (II), mean that this substituent (radical) is an alkenyl radical having a carbon atom number of 2 to 10. This carbon radical is preferably monounsaturated, but it may optionally also be di- or polyunsaturated. With regard to linearity, branches and cyclic components, the equivalent statements to those defined above with reference to the C₁-C₃₀-alkyl radicals are applicable. Preferably, C₂-C₁₀-alkenyl in the context of the present invention is vinyl, 1-allyl, 3-allyl, 2-allyl, cis- or trans-2-butenyl, w-butenyl.

In the context of the present invention, the term “aryl”, as defined above, for example, for the R¹ radical in formula (II), means that the substituent (radical) is an aromatic system. The aromatic system may be a monocyclic, bicyclic or optionally polycyclic aromatic system. In the case of polycyclic aromatic systems, it is optionally possible for individual cycles to be wholly or partly saturated. Preferred examples of aryl are phenyl, naphthyl or anthracyl, especially phenyl.

### Hardener (H)

According to the invention, the thermosettably crosslinkable epoxy resin system comprises at least one hardener (H).

Suitable hardeners (H) are described, for example, in B. Ellis, “Chemistry and Technology of Epoxy Resins”, Blackie Academic & Professional, 1993, p. 37-56. Suitable hardeners (H) are, for example, selected from the group consisting of dicarboxylic anhydrides and amines.

Examples of suitable amines are aliphatic amines, cycloaliphatic amines, aromatic amines, aliphatic-aromatic amines and dicyanamides. Also suitable are polyetheramines, where the polyether segment preferably consists of ethylene oxide, propylene oxide or butylene oxide units. It is also possible to use mixtures of different polyetheramines or mixtures of polyetheramines and other amines.

Additionally suitable are polyamidoamines and imidazolines.

Preferred hardeners (H) are selected from the group consisting of 1,3-diaminobenzene, 2,6-bis(aminomethyl)piperidine, diethylenetriamine, triethylenetetramine, 4,4″-diaminodiphenyl sulfone, phthalic anhydride and hexahydrophthalic anhydride.

Anhydrides or acids suitable as hardeners are described in B. Ellis, “Chemistry and Technology of Epoxy Resins”, Blackie Academic & Professional, 1993, p. 60-65. Preference is given to using phthalic anhydride and hexahydrophthalic anhydride.

The ratio of epoxy compound (E) to hardener (H), based on the ratio of the epoxy groups in (E) to the number of substitutable hydrogen atoms in the amino groups in hardener (H), can in principle be selected arbitrarily.

Preferably, the ratio of epoxy compound (E) to hardener (H) is adjusted such that the ratio of the number of epoxy groups in epoxy compound (E) to the number of substitutable hydrogen atoms in the amino groups in hardener (H) is 0.2:1 to 1:1, more preferably 0.33:1 to 1:1, even more preferably 0.5:1 to 1:1 or preferably 1:0.2 to 1:1, more preferably 1:0.33 to 1:1, even more preferably 1:0.5 to 1:1.

Preferred stoichiometric ratios for the curing of epoxy resins with anhydrides or dicarboxylic acids are known to those skilled in the art.

The number of epoxy groups in the epoxy compound (E) can be determined via the respective EEW (epoxy equivalent weight). In this context, for example, an EEW of 182 means that 182 g of the epoxy resin contain 1 mol of epoxy groups.

Over and above the components (A) and (B) mentioned, the thermosettably crosslinkable epoxy resin system may also comprise further compounds, for example hardening accelerators ((HA); component (C)) and/or reactive diluents ((RD); component (D)).

Examples of suitable reactive diluents (RD) are as follows: 4-butanediol bisglycidyl ether, 1,6-hexanediol bisglycidyl ether, glycidyl neodecanoate, glycidyl versatate, 2-ethylhexyl glycidyl ether, C₈-C₁₀-alkyl glycidyl ether, C₁₂-C₁₄-alkyl glycidyl ether, p-tert-butyl glycidyl ether, butyl glycidyl ether, nonylphenyl glycidyl ether, p-tert-butylphenyl glycidyl ether, phenyl glycidyl ether, o-cresyl glycidyl ether, polyoxypropylene glycol diglycidyl ether, trimethylolpropane triglycidyl ether (TMP), glycerol triglycidyl ether and triglycidylparaaminophenol (TGPAP).

The hardening accelerator (HA) used may, for example, be 2-ethyl-4-methylimidazole. Further suitable hardening accelerators are described in B. Ellis, “Chemistry and Technology of Epoxy Resins”, Blackie Academic & Professional, 1993, p. 56 to 61.

Further constituents may be solvents, for example benzyl alcohol or acetone, or catalysts such as Lewis acids (for example BF₃ adducts), Lewis bases (for example imidazoles or tertiary amines) or Brønsted acids (for example methanesulfonic acid).

### Thermoplastic Polymer Having a Porosity of 10% to 90%

According to the invention, it is possible to use any thermoplastic polymers having a porosity in the range from 10% to 90%, preferably in the range from 15% to 85% and more preferably in the range from 20% to 80%.

According to the invention, “porosity” is understood to mean the ratio of cavity volume of the pores present in the thermoplastic polymer to the total volume of the thermoplastic polymer.

According to the invention, the porosity of the thermoplastic polymer is determined by measuring the density of the porous thermoplastic polymer and comparing it with the density of the compact polymer.

Suitable thermoplastic polymers are, for example, selected from the group consisting of polyarylene ethers, polyphenylene ethers, polyetherimides and mixtures of polyarylene ethers, polyphenylene ethers and polyetherimides.

The present invention thus also provides a process in which the thermoplastic polymer is selected from the group consisting of polyarylene ethers, polyphenylene ethers, polyetherimides and mixtures of polyarylene ethers, polyphenylene ethers and polyetherimides.

Preferably, the thermoplastic polymer is at least one polyarylene ether (P) formed from units of the general formula (I)

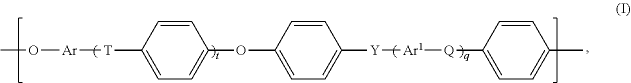

with the following definitions:
t, q: independently 0, 1, 2 or 3,
Q, T, Y: each independently a chemical bond or group selected from —O—, —S—, —SO₂—, S═O, C═O, —N═N—, —CR^{a}R^{b}— where R^{a} and R^{b} are each independently a hydrogen atom or a C₁-C₁₂-alkyl, C₁-C₁₂-alkoxy or C₈-C₁₈-aryl group, where at least one of Q, T and Y is different than —O—, and at least one of Q, T and Y is —SO₂— and
Ar, Ar¹: each independently an arylene group having from 6 to 18 carbon atoms.

If Q, T or Y, with the abovementioned prerequisites, is a chemical bond, this is understood to mean that the adjacent group to the left and the adjacent group to the right are joined directly to one another via a chemical bond.

Preferably, Q, T and Y in formula (I), however, are each independently selected from —O— and —SO₂—, with the proviso that at least one from the group consisting of Q, T and Y is —SO₂—.

When Q, T or Y is —CR^{a}R^{b}—, R^{a} and R^{b} are each independently a hydrogen atom or a C₁-C₁₂-alkyl, C₁-C₁₂-alkoxy or C₆-C₁₈-aryl group.

Preferred C₁-C₁₂-alkyl groups include linear and branched, saturated alkyl groups having from 1 to 12 carbon atoms. Particular mention should be made of the following radicals: C₁-C₆-alkyl radical such as methyl, ethyl, n-propyl, isopropyl, n-butyl, sec-butyl, 2- or 3-methylpentyl, and longer-chain radicals such as unbranched heptyl, octyl, nonyl, decyl, undecyl, lauryl and the singly or multiply branched analogs thereof.

Useful alkyl radicals in the aforementioned usable C₁-C₁₂-alkoxy groups include the alkyl groups defined further up having from 1 to 12 carbon atoms. Cycloalkyl radicals usable with preference include especially C₃-C₁₂-cycloalkyl radicals, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, dimethyl, and -trimethyl.

Ar and Ar¹ are each independently a C₆-C₁₈-arylene group. Proceeding from the starting materials described further down, Ar is preferably derived from an electron-rich, readily electrophilically attackable aromatic substance which is preferably selected from the group consisting of hydroquinone, resorcinol, dihydroxynaphthalene, especially 2,7-dihydroxynaphthalene, and 4,4′-bisphenol. Ar¹ is preferably an unsubstituted C₆- or C₁₂-arylene group.

Useful C₆-C₁₈-arylene groups Ar and Ar¹ include especially phenylene groups such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Preferably, Ar and Ar¹ in the preferred embodiment of formula (I) are each independently selected from the group consisting of 1,4-phenylene, 1,3-phenylene, naphthylene, especially 2,7-dihydroxynaphthylene, and 4,4′-bisphenylene.

Units present with preference in the context of the polyarylene ether (P) are those comprising at least one of the following repeat structural units Ia to Io:

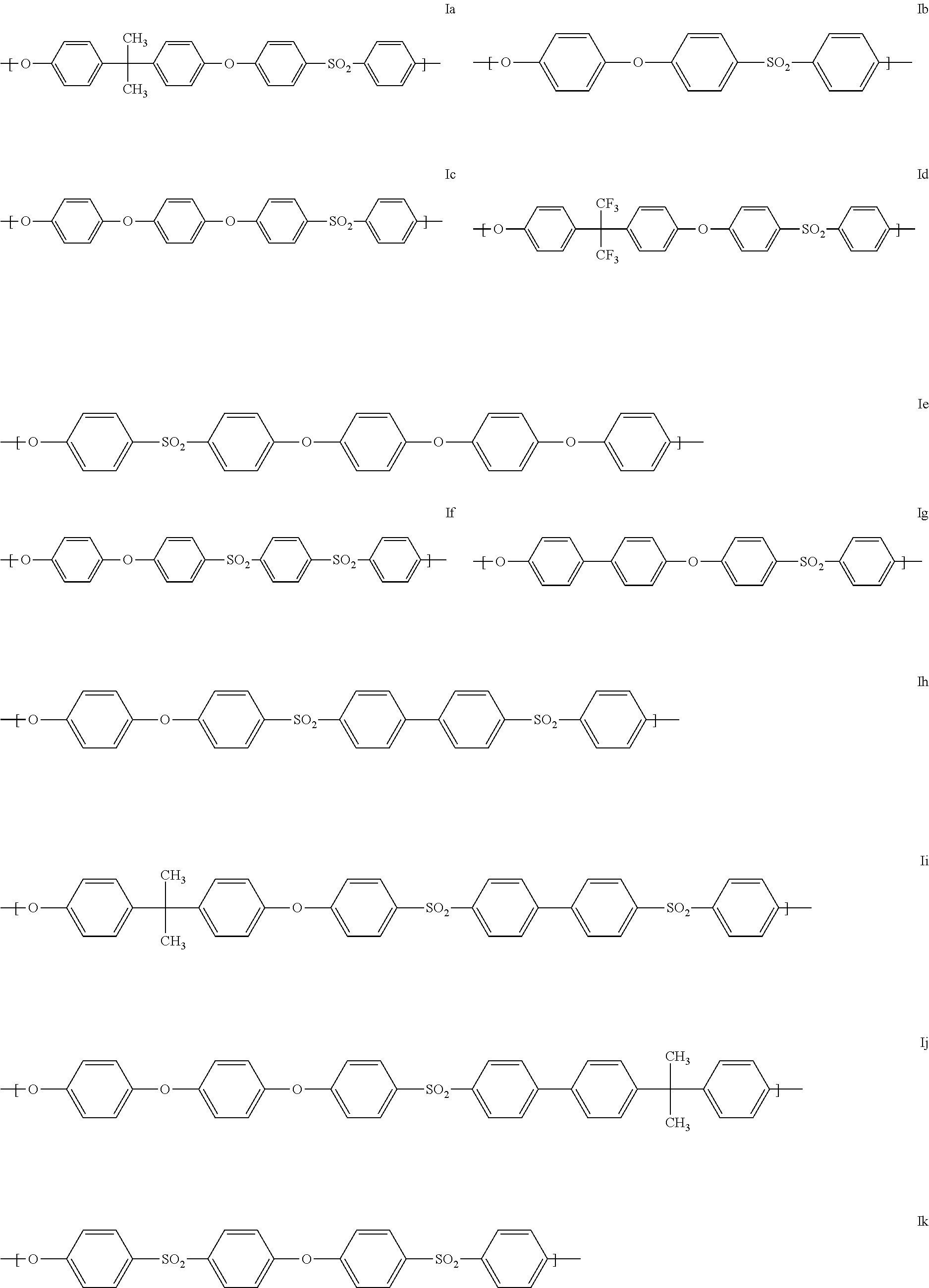

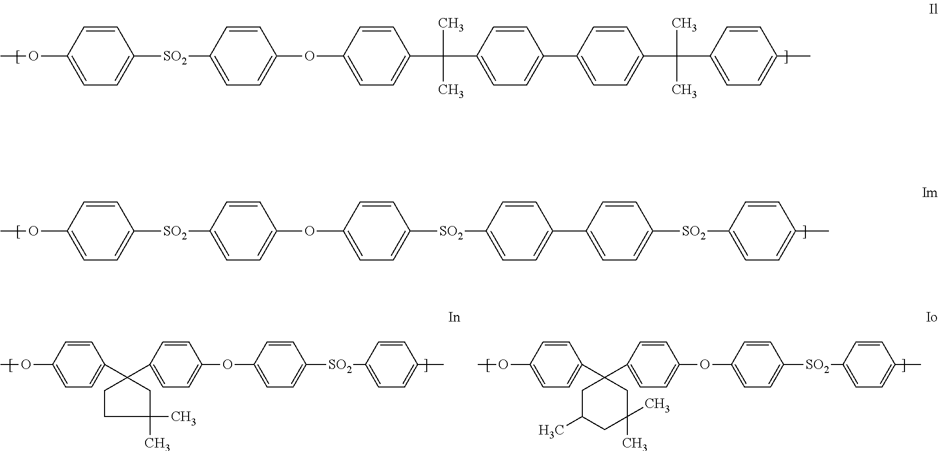

In addition to the preferred units Ia to Io, preference is also given to those units in which one or more 1,4-dihydroxyphenyl units are replaced by resorcinol or dihydroxynaphthalene units.

Particularly preferred units of the general formula I are units Ia, Ig and Ik. It is also particularly preferred when the polyarylene ethers of the polyarylene ethers (P) are formed essentially from one kind of unit of the general formula I, especially from one unit selected from Ia, Ig and Ik.

In a particularly preferred embodiment, Ar=1,4-phenylene, t=1, q=0, T=Y═SO₂, Polyarylene ethers of this kind are referred to as polyether sulfone (PESU).

Particularly preferred thermoplastic polymers are polyether sulfones (PESU), polysulfones (PSU) and polyphenylene sulfones (PPSU), particular preference being given to polyether sulfone (PESU).

Polyether sulfones (PESU) have repeat structural units of the formula (Ik); preferably, polyethersulfones consist of repeat structural units of the formula (Ik).

Polysulfones (PSU) have repeat structural units of the formula (Ia); preferably, polysulfones consist of repeat structural units of the formula (Ia).

Polyphenylene sulfones (PPSU) have repeat structural units of the formula (Ig); preferably, polyphenylene sulfones consist of repeat structural units of the formula (Ig).

Particularly preferred thermoplastic polymers having a porosity in the range from 10% to 90% are selected from the group consisting of polyether sulfones (PESU), polysulfones (PSU), polyphenylene sulfones (PPSU) and copolymers of (PESU) and/or (PSU) and/or (PPSU).

The polyarylene ether (P) preferably has at least 60%, more preferably at least 80% and especially at least 90% phenol end groups, based on the total number of end groups.

According to the invention, “phenol end groups” is understood to mean both phenolic end groups (OH end groups) and phenoxide end groups (O⁻ end groups). According to the invention, “phenol end group” is thus understood to mean the sum total of the phenolic end groups present in the polyarylene ether (P) and the phenoxide end groups present in the polyarylene ether (P).

The polyarylene ethers (P) preferred above as thermoplastic polymers having a porosity in the range from 10% to 90% can be prepared proceeding from polyarylene ethers (P) having no pores. “Having no pores” is understood in accordance with the invention to mean a porosity of less than 10%, preferably less than 5%, more preferably less than 2% and especially less than 1% and most preferably less than 0.1%.

Processes for preparing polyarylene ethers (P) having no pores are described, for example, in WO 2010/057822.

Preferably, the polyarylene ethers (P) having no pores have mean molecular weights Mₙ (number-average) in the range from 2000 to 60 000 g/mol, especially 5000 to 40 000 g/mol, determined by means of gel permeation chromatography in dimethylacetamide solvent against narrow-distribution polymethylmethacrylate as standard.

Preferably, the polyarylene ethers (P) having no pores have relative viscosities of 0.20 to 0.95 dl/g, especially of 0.30 to 0.80. According to the solubility of the polyarylene ether sulfones, the relative viscosities are measured either in 1 percent by weight N-methylpyrrolidone solution, in mixtures of phenol and dichlorobenzene, or in 96 percent sulfuric acid, at 20° C. or 25° C. in each case.

Suitable polyphenylene ethers are described in D. Aycock, Encyclopedia of Polymer Science and Engineering, 2nd edition, 1988 John Wiley & Sons, Vol. 13, p. 1. Suitable polyetherimides are known from G. Yeager, Encyclopedia of Polymer Science and Technology, 3rd edition 2004 John Wiley & Sons, Vol 11, p. 88.

The preparation of the thermoplastic polymer having a porosity in the range from 10% to 90% may proceed from a thermoplastic polymer without pores by methods known per se to those skilled in the art. It is possible here, for example, to use methods of membrane production by phase inversion as described, for example, in “The Formation Mechanism of Asymmetric Membranes”, H. Strathmann, K. Koch, P. Aimar, R. W. Baker; Desalination 16 (1975), 179-203.

A preferred process for preparing thermoplastic polymers having a porosity in the range from 10% to 90% is described by way of example hereinafter with reference to the polyarylene ethers (P) preferred in accordance with the invention.

A preferred process for preparing a polyarylene ether (P) having a porosity in the range from 10% to 90% comprises the following steps:
(i) providing a solution comprising at least one polyarylene ether (P), optionally at least one hydrophilic polymer and at least one aprotic solvent and
(ii) contacting the solution provided in process step (i) with a coagulant to obtain the polyarylene ether (P) having a porosity in the range from 10% to 90%.

It will be apparent that the hydrophilic polymer used optionally in process step (i) is different than the thermoplastic polymers, especially than the polyarylene ethers (P) that are preferred in accordance with the invention. Since the polyarylene ethers (P) are provided dissolved in an aprotic solvent in process step (i), the polyarylene ethers (P) in process step (i) do not have any pores.

Aprotic solvents used may in principle be any aprotic solvents in which the thermoplastic polymer, preferably the polyarylene ether (P), is soluble.

Preferred aprotic solvents for provision of the solution in step (i) are selected from the group consisting of N-methylpyrrolidone (N-methyl-2-pyrrolidone; NMP), N-ethyl-2-pyrrolidone (NEP), dimethylacetamide, dimethyl sulfoxide, dimethylformamide and sulfolane (tetrahydrothiophene 1,1-dioxide). Particular preference is given to N-methylpyrrolidone, NEP, dimethylacetamide, dimethyl sulfoxide and dimethylformamide. N-Methylpyrrolidone is especially preferred.

The solution can be provided in step (i) in customary vessels, especially those comprising a stirrer apparatus and preferably an apparatus for temperature control. The solution is preferably prepared in step (i) of the process of the invention with stirring. The dissolution of the polyarylene ether (P) and the hydrophilic polymer may be successive or simultaneous.

Step (i) is preferably conducted at elevated temperature, especially from 20° C. to 120° C., preferably from 40° C. to 100° C. The person skilled in the art will choose the temperature particularly depending on the aprotic polar solvent.

Preferably, the solution provided in step (i) comprises from 5% to 45% by weight, especially from 9% to 35% by weight, of the polyarylene ether (P), based on the total weight of the solution.

The sum total of the polyarylene ether (P) of the invention and the optionally used hydrophilic polymer in the solution provided in step (i) is generally 5% to 50% by weight, especially from 9% to 40% by weight, based on the total weight of the solution.

The percentage by weight ratio of polyarylene ether (P) of the invention to hydrophilic polymer in the solution in step (i) is generally in the range from 100:0 to 50:50.

Suitable hydrophilic polymers are polymers soluble in the coagulant which is used in process step (ii). Suitable hydrophilic polymers present in the solution in process step (i) are polyvinylpyrrolidones and polyalkylene glycols. Suitable polyalkylene glycols are, for example, polyethylene glycols and polypropylene glycols, preference being given to polyethylene glycol among the polyalkylene glycols.

A particularly preferred hydrophilic polymer in process step (i) is polyvinylpyrrolidone having a weight-average molecular weight (Mw) in the range from 10 000 to 2 000 000 g/mol, preferably in the range from 30 000 to 1 600 000 g/mol. The molecular weight Mw is determined by GPC analysis with 80/20 water/acetonitrile as eluent and PVP standards. Preferably, the solution provided in process step (i) is degassed prior to the performance of process step (ii).

In process step (ii), the solution provided in process step (i) is contacted with a coagulant, which affords the polyarylene ether (P) having a porosity in the range from 10% to 90%.

The coagulant used in process step (ii) preferably comprises at least one protic solvent selected from the group consisting of water, methanol, ethanol, 1-propanol, 2-propanol and glycerol.

A particularly preferred protic solvent present in the coagulant is water,

In a further preferred embodiment, the coagulant comprises at least 80% by weight, preferably at least 90% by weight and especially preferably at least 95% by weight of a protic solvent, based in each case on the total weight of the coagulant, a particularly preferred protic solvent being water.

In process step (ii), a polyarylene ether (P) having a porosity in the range from 10% to 90% is obtained. The polyarylene ether (P) having a porosity in the range from 10% to 90% obtained in process step (ii) can be subjected to further workup and purification steps. Preferably, the polyarylene ether (P) obtained in process step (ii) is subjected to an extraction step, preferably using the coagulant as extractant. After the extraction step, the polyarylene ether (P) having a porosity in the range from 10% to 90% can be subjected to a drying step at temperatures in the range from 50 to 120° C., preference being given to conducting the drying under reduced pressure.

The form of the polyarylene ether (P) having a porosity in the range from 10% to 90% obtained in process step (ii) may vary. The polyarylene ether (P) having a porosity in the range from 10% to 90% obtained in process step (ii) may be obtained, for example, in the form of a film or in the form of a fiber. For production of films, in process step (i), the solution is provided in the form of a film, the film subsequently being contacted with the coagulant. If the polyarylene ether (P) is to be obtained in the form of a fiber in process step (ii), the solution provided in process step (i) is subjected, for example, to a wet spinning step before it is contacted with the coagulant in process step (ii).

The fibers of the polyarylene ether (P) having a porosity in the range from 10% to 90% thus obtained can be processed further to give fabrics. The thermoplastic polymer used in process step b), especially the polyarylene ether (P) having a porosity in the range from 10% to 90%, is preferably used in the form of a film, fiber or fabric.

Molds used in the process of the invention may be any molds suitable for primary shaping.

The thermosettably crosslinkable resin system, preferably the thermosettably crosslinkable epoxy resin system, can be provided by methods known to those skilled in the art. For this purpose, preferably the at least one epoxy compound (E), the at least one hardener (H) and optionally the hardening accelerator (HA) and optionally the reactive diluent (RD) are mixed, which affords the thermosettably curable epoxy resin system. Preferably, however, the components of the epoxy resin system are mixed outside the mold and the thermosettably crosslinkable epoxy resin system thus obtained is subsequently introduced into the mold.

The provision of the thermosettably crosslinkable epoxy resin system in process step a) is generally effected at temperatures in the range from 0 to 100° C., preferably in the range from 10 to 90° C., more preferably in the range from 15 to 80° C. and especially preferably in the range from 20 to 75° C.

The crosslinking in process step b) is generally effected at temperatures in the range from 20 to 300° C., preferably in the range from 25 to 275° C., more preferably in the range from 25 to 250° C. and especially preferably in the range from 25 to 245° C.

In a preferred embodiment, the thermoplastic polymer having a porosity in the range from 10% to 90% is provided in the mold prior to the provision of the thermosettably crosslinkable resin system.

In this embodiment, in process step a1), the thermoplastic polymer having a porosity of 10% to 90% is introduced into the mold and, subsequently, in process step a2), the thermosettably crosslinkable resin system, preferably the thermosettably crosslinkable epoxy resin system, is injected or sucked into the mold and, subsequently, the above-described process step b) is conducted.

In a further embodiment of the present invention, the thermoset molding comprises at least one reinforcing material. Preference is given to fibrous reinforcing materials, for example carbon fibers, potassium titanate whiskers, aramid fibers and preferably glass fibers.

Preferred reinforcing materials are continuous fibers selected from loop-drawn knitted fabrics, loop-formed knitted fabrics and woven fabrics, preference being given to glass fibers as fiber material. In addition, it is possible to use unidirectional continuous fibers. Such single-thread continuous fibers are also referred to as “monofils”. If unidirectional continuous fibers are used, a multitude of continuous glass fibers used in parallel to one another is used. In this case, preference is given to using unidirectional layers of continuous fibers aligned parallel to one another. Furthermore, it is possible to use bidirectional or multidirectional layers of continuous fibers. For production of thermoset moldings comprising at least one reinforcing material, the reinforcing material is preferably likewise introduced into the mold before the thermosettably crosslinkable resin system, preferably the thermosettably crosslinkable epoxy resin system, is injected into the mold (provided in the mold).

Preference is given to first providing a reinforcing material to which the thermoplastic polymer having a porosity in the range from 10% to 90% is applied. The thermoplastic polymer having a porosity in the range from 10% to 90% may be applied here to the reinforcing material in the form of a film, in the form of fibers or in the form of fabrics. Subsequently, the reinforcing material to which the thermoplastic polymer has been added, having a porosity in the range from 10% to 90% is contacted in the mold with the thermosettably crosslinkable resin system, preferably with the thermosettably crosslinkable epoxy resin system.

During process step b), the thermosettably crosslinkable resin system crosslinks in the mold, which affords the thermoset molding. This operation, as described above, is also referred to as “hardening”.

As already set out above, the thermosettably crosslinkable resin system is provided in process step a) in unhardened or only partly hardened form. In process step b), the thermoset molding is obtained in hardened form, preferably in fully hardened form. According to the invention, process step a) is considered to be complete when the injection of the thermosettably crosslinkable resin system, preferably the thermosettably crosslinkable epoxy resin system, into the mold has ended. According to the invention, process step b) thus begins immediately after process step a), i.e. the injection of the thermosettably crosslinkable resin system into the mold, has been completed.

During the crosslinking in process step b), the thermoplastic polymer having a porosity in the range from 10% to 90%, preferably the polyarylene ether (P), dissolves in the thermosettably crosslinkable resin system.

After process step b), the thermoset molding is obtained. This thermoset molding comprises the thermoplastic polymer, preferably the polyarylene ether (P). It will be apparent that, in this dissolution operation, the pores originally present in the thermoplastic polymer are lost. The figures relating to the porosity of the thermoplastic polymer, preferably the polyarylene ether (P), thus relate in accordance with the invention to the moment immediately after the end of process step a), i.e. the moment after which the injection of the thermosettably crosslinkable resin system into the mold has ended.

The thermosettably crosslinkable resin system provided in process step a), preferably the thermosettably crosslinkable epoxy resin system, generally has a viscosity in the range from 5 to 1000 mPa·s, preferably in the range from 10 to 800 mPa·s, more preferably in the range from 20 to 750 mPa·s and especially preferably in the range from 25 to 600 mPa·s, measured at 60° C. with a plate-plate measurement arrangement at a shear rate of 1 Hz.

The thermoset molding obtainable by the process of the invention is notable for a favorable intrinsic color and good notched impact strength.

The present invention is elucidated in detail by the examples which follow, but without being restricted thereto.

### EXAMPLES

The thermoplastic polymer used was a polyether sulfone having a viscosity number of 56 ml/g. The viscosity number was determined in 1 percent solution in 1/1 phenol/o-dichlorobenzene. The polyether sulfone had at least 60% OH end groups, based on the total number of end groups. The polyether sulfone is available under the “Ultrason® E 2020 P SR” trade name from BASF SE.

The epoxy compound (E) used was a bisphenol A diglycidyl ether having a mean molecular weight of 395 g/mol.

The hardener (H) used was hexahydrophthalic anhydride.

The hardening accelerator (HA) used was 2-ethyl-4-methylimidazole.

Preparation of a Thermoplastic Polymer without Pores (Noninventive); “F I” Hereinafter

In a DSM miniextruder (15 cc type) equipped with a film die, 15 g of the above-described polyether sulfone were melted at a temperature of 340° C. For this purpose, the polyether sulfone was circulated through an internal return flow channel for five minutes. Subsequently, the polyether sulfone was discharged through the film die having a gap width of 150 μm. The foil (F I) obtained was transparent, but highly discolored, very brittle and friable. On dissolution of 1 g of the foil in 20 mL of N-methylpyrrolidone (NMP) at 25° C. for a period of eight hours, an insoluble fraction remained. The density of the foil was determined by gravimetric means and was 1.37 g/cm³.

Preparation of a Thermoplastic Polymer Having a Porosity in the Range from 10% to 90% (Inventive); “F II” Hereinafter

A solution of 30 g of the above-described polyether sulfone, 5 g of K30 polyvinylpyrrolidone (hydrophilic polymer) in 65 g of NMP was formed at room temperature (25° C.) with the aid of a coating bar having a width of 10 cm into a solution film of thickness 300 μm on a glass plate. Subsequently, the glass plate was transferred into a water bath (coagulant), which gave a white film which became detached from the glass plate after three minutes. The film (F II) thus obtained was subsequently washed with warm water at 60° C. for four hours and then dried at 100° C. under reduced pressure for twelve hours. After drying, the thermoplastic polymer having a porosity of 10% to 90% was obtained. The presence of pores is demonstrated by the lack of transparency and the distinct reduction in density. The density of the film (F II) was determined by gravimetric means and was 0.56 g/cm³. The porosity of the film is 58.8%.

Preparation of a Thermoplastic Polymer Having a Porosity in the Range from 10% to 90% (Inventive); “F Ill” Hereinafter

A solution of 30 g of the above-described polyether sulfone, 5 g of polyethyleneoxide (Mn=6000 g/mol; hydrophilic polymer) in 65 g of NMP was formed at room temperature (25° C.) with the aid of a coating bar having a width of 10 cm into a solution film of thickness 300 μm on a glass plate. Subsequently, the glass plate was transferred into a water bath (coagulant), which gave a white film which became detached from the glass plate after 1.5 minutes. The film (F III) thus obtained was subsequently washed with warm water at 60° C. for four hours and then dried at 100° C. under reduced pressure for twelve hours. After drying, the thermoplastic polymer having a porosity of 10% to 90% was obtained. The presence of pores is demonstrated by the lack of transparency and the distinct reduction in density. The density of the film (F III) was determined by gravimetric means and was 0.75 g/cm³. The porosity of the film is 45.3%.

Preparation of a Thermoplastic Polymer Having a Porosity in the Range from 10% to 90% (Inventive); “F IV” Hereinafter

A solution of 40 g of the above-described polyether sulfone in 60 g of NMP was formed at room temperature (25° C.) with the aid of a coating bar having a width of 10 cm into a solution film of thickness 300 μm on a glass plate. Subsequently, the glass plate was transferred into a water bath (coagulant), which gave a white film which became detached from the glass plate after four minutes. The film (F IV) thus obtained was subsequently extracted with warm water at 85° C. for ten hours and then dried at 100° C. under reduced pressure for twelve hours. After drying, the thermoplastic polymer having a porosity of 10% to 90% was obtained. The presence of pores is demonstrated by the lack of transparency and the distinct reduction in density. The density of the film (F IV) was determined by gravimetric means and was 0.87 g/cm³. The porosity of the film is 36.5%.

Preparation of a Thermoplastic Polymer Having a Porosity in the Range from 10% to 90% (Inventive); “F V” Hereinafter

A solution of 15 g of the above-described polyether sulfone, 5 g of K30 polyvinylpyrrolidone (hydrophilic polymer) in 80 g of NMP was formed at room temperature (25° C.) with the aid of a coating bar having a width of 10 cm into a solution film of thickness 150 μm on a glass plate. Subsequently, the glass plate was transferred into a water bath (coagulant), which gave a white film which became detached from the glass plate after two minutes. The film (F V) thus obtained was subsequently extracted with warm water at 85° C. for ten hours and then dried at 100° C. under reduced pressure for twelve hours. After drying, the thermoplastic polymer having a porosity of 10% to 90% was obtained. The presence of pores is demonstrated by the lack of transparency and the distinct reduction in density. The density of the film (F V) was determined by gravimetric means and was 0.28 g/cm³. The porosity of the film is 79.6%.

Preparation of a Thermoplastic Polymer Having a Porosity Greater than 90% (Comparative); “F VI” Hereinafter

A solution of 7.5 g of the above-described polyether sulfone, 5 g of K30 polyvinylpyrrolidone (hydrophilic polymer) in 87.5 g of NMP was formed at room temperature (25° C.) with the aid of a coating bar having a width of 10 cm into a solution film of thickness 50 μm on a glass plate. Subsequently, the glass plate was transferred into a water bath (coagulant), which gave a white film which became detached from the glass plate after 1.5 minutes. The film (F VI) thus obtained was subsequently extracted with warm water at 85° C. for ten hours and then dried at 100° C. under reduced pressure for twelve hours. After drying, the thermoplastic polymer having a porosity greater than 90% was obtained as a brittle white film (F VI). The presence of pores is demonstrated by the lack of transparency and the distinct reduction in density. The density of the film (F VI) was determined by gravimetric means and was 0.11 g/cm³. The porosity of the film is 92.0%.

Processing of the film (F VI) was not possible due to the high porosity,

Preparation of a Thermoplastic Polymer Having a Porosity Smaller than 10% (Comparative); “F VII” Hereinafter

A solution of 55 g of the above-described polyether sulfone in 45 g of NMP was formed at room temperature (25° C.) with the aid of a coating bar having a width of 10 cm into a solution film of thickness 300 μm on a glass plate. Subsequently, the glass plate was transferred into a water bath (coagulant), which gave a white film which became detached from the glass plate after 60 minutes. The film (F VII) thus obtained was subsequently extracted with warm water at 85° C. for ten hours. Subsequently, the film was further dried at 60° C. for two hours, then at 100° C. for another 2 hours and at 140° C. for six hours each under reduced pressure. After drying, the thermoplastic polymer having a porosity smaller than 10% was obtained. The presence of pores is demonstrated by the at least partial lack of transparency and the slight reduction in density. The density of the film (F VII) was determined by gravimetric means and was 1.28 g/cm³. The porosity of the film is 6.6%.

The presence of transparent areas in the thermoplastic polymer can be attributed to a residual amount of NMP of approximately 2 wt-%, based on the total weight of the thermoplastic polymer. The film could not be used due to the high content of NMP.

Preparation of a Thermoplastic Polymer Having a Porosity in the Range from 10% to 90% (Inventive); “Fiber I” Hereinafter

A solution of 300 g of the above-described polyether sulfone, 50 g of K30 polyvinylpyrrolidone (hydrophilic polymer) in 650 g of NMP was formed at room temperature (25° C.) and extruded into a precipitation bath containing water with the aid of an annular gap. The hollow fiber (Fiber I) thus obtained was subsequently washed with warm water at 60° C. for eight hours and then dried at 100° C. under reduced pressure for twelve hours. After drying, the thermoplastic polymer was obtained as a white hollow fiber (Fiber I) having an external diameter of 450±25 μm and an internal diameter of 300±15 μm as well as a porosity of 10% to 90%. The presence of pores is demonstrated by the lack of transparency and the distinct reduction in density. The density of the hollow fiber (Fiber I) was determined by gravimetric means and was 0.66 g/cm³. The porosity of the film is 51.8%.

### Production of the Thermoset Moldings

For production of the thermoset moldings, in each case 120 g of the epoxy compound (E) and 100 g of the hardener (H) were mixed at 80° C. until the distribution was homogeneous. Thereafter, at 80° C., the amounts of the foil (F I), the film (F II to F V) or the hollow fiber (Fiber I) specified in table 1 below in each case were added. Subsequently, the mixture was stirred until the foil (F I), the film (F II to F V) or the hollow fiber (Fiber I) had dissolved. The time taken for dissolution was determined. This was followed by cooling down to 40° C. and subsequent addition of 2.4 g of the hardening accelerator (HA) at 40° C. while stirring vigorously. Subsequently, the mixture thus obtained was degassed under reduced pressure for 10 minutes in order to remove bubbles. Then the mixture was hardened at a temperature of 80° C. for 24 hours and subsequently post-hardened at 200° C. for a period of 30 minutes.

The thermoset moldings thus obtained were used to elaborate samples of dimensions 80*10*2 mm. After introduction of a notch (depth 2 mm, radius 2.5 mm), the notched impact strength was tested in accordance with ISO 180. The color of the sample was assessed visually (+ very good; +/o good; o satisfactory; o/− adequate; − inadequate; −− unsatisfactory).

The results are listed in the table below.

TABLE 1

| Molding | | | | | | | | | | | |
|---|---|---|---|---|---|---|---|---|---|---|---|
| compound | C1 | C2 | C3 | 4 | 5 | 6 | 7 | 8 | 9 | 10 | 11 |
| A* | 90 | 85 | 80 | 90 | 85 | 20 | 85 | 85 | 85 | 85 | 80 |
| F I | 10 | 15 | 20 | — | — | — | — | — | — | — | — |
| F II | — | — | — | 10 | 15 | 20 | — | — | — | — | — |
| F III | — | — | — | — | — | — | 15 | — | — | — | — |
| F IV | — | — | — | — | — | — | — | 15 | — | — | — |
| FV | — | — | — | — | — | — | — | — | 15 | — | — |
| Fiber I | — | — | — | — | — | — | — | — | — | 15 | 20 |
| Mixing time [h] | 5.2 | 6.5 | 7 | 2.5 | 3.2 | 4 | 4 | 4.25 | 3 | 3.5 | 4.25 |
| Transparency | no | no | no | no | no | no | no | no | no | no | No |
| Intrinsic color | o/− | − | − − | + | +/o | o | +/o | +/o | +/o | +/o | +/o |
| aₖ [kJ/m²] | 0.23 | 0.26 | 0.27 | 0.87 | 0.92 | 1.06 | 0.47 | 0.44 | 0.47 | 0.46 | 0.50 |

A* indicates the proportion of the epoxy resin system consisting of epoxy compound (E), hardener (H) and hardening accelerator (HA) in percent by weight. The proportions of the foil (F I), the film (F II to F V) or the hollow fiber (Fiber I) are likewise stated in percent by weight. C1, C2 and C3 are comparative examples in which the nonporous foil (F I) is used. Examples 4, 5 and 6 are inventive examples in which the porous film (F II) is used. Examples 7 to 9 are further inventive examples in which the porous film (F III) is used in example 7, the porous film (F IV) is used in example 8 and the porous film (F V) is used in example 9. The examples 10 and 11 are further inventive examples in which the hollow fiber (Fiber I) is used.

The present examples show that the use of thermoplastic polymers having a porosity in the range from 10% to 90% enables much quicker dissolution of the thermoplastic polymer in the epoxy resin system. Furthermore, thermoset moldings having a distinct improvement in intrinsic color and a distinct improvement in notched impact strength are obtained if the crosslinking of the thermosettably crosslinkable resin system is conducted in the presence of a thermoplastic polymer having a porosity in the range from 10% to 90%.

1.-15. (canceled)

16. A process for producing a thermoset molding, comprising the steps of
a) providing a thermosettably crosslinkable resin system in a mold,
b) crosslinking the thermosettably crosslinkable resin system provided in step a) in the mold in the presence of a thermoplastic polymer having a porosity of 10% to 90% to obtain the thermoset molding,
c) removing the thermoset molding from the mold.

17. The process according to claim 16, wherein the thermosettably crosslinkable resin system provided in process step a) is selected from the group consisting of thermosettably crosslinkable epoxy resin systems, thermosettably crosslinkable urea-formaldehyde resin systems, thermosettably crosslinkable melamine-formaldehyde resin systems, thermosettably crosslinkable melamine-phenol-formaldehyde resin systems, thermosettably crosslinkable phenol-formaldehyde resin systems and thermosettably crosslinkable bismaleimide resin systems.

18. The process according to claim 16, wherein the thermoplastic polymer is selected from the group consisting of polyarylene ethers, polyphenylene ethers, polyetherimides and mixtures of polyarylene ethers, polyphenylene ethers and polyetherimides.

19. The process according to claim 16, wherein the thermoplastic polymer is at least one polyarylene ether (P) formed from units of the general formula (I) 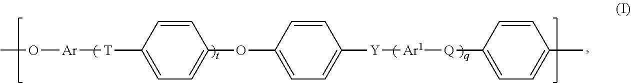
with the following definitions:
t, q: independently 0, 1, 2 or 3,
Q, T, Y: each independently a chemical bond or group selected from —O—, —S—, —SO₂—, S═O, C═O, —N═N—, —CR^{a}R^{b}— where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂— and
Ar, Ar¹: each independently an arylene group having from 6 to 18 carbon atoms.

20. The process according to claim 19, wherein the polyarylene ether (P) has end groups, where at least 60% of the end groups are phenol end groups, based on the total number of end groups in the polyarylene ether (P).

21. The process according to claim 16, wherein the thermoplastic polymer is selected from the group consisting of polyether sulfones (PESU), polysulfones (PSU) and polyphenyl sulfones (PPSU).

22. The process according to claim 16, wherein the thermosettably crosslinkable resin system provided in process step a) is an epoxy resin system comprising the following components:
(A) at least one epoxy compound (E) having at least one epoxy group per molecule, and
(B) at least one hardener (H).

23. The process according to claim 22, wherein the epoxy compound (E) has at least two epoxy groups per molecule.

24. The process according to claim 22, wherein the epoxy compound (E) is a bisglycidyl ether based on bisphenols of the general formula (II): 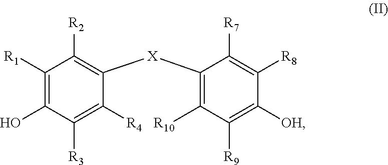
where:
R¹ to R⁴ and R⁷ to R¹⁰ are each independently H, C₁-C₆-alkyl, aryl, halogen or C₂-C₁₀-alkenyl, where R¹ to R⁴ and R⁷ to R¹⁰ may also be part of a ring system;
X is CR⁵R⁶ or SO₂;
if X is CR⁵R⁶, R⁵ and R⁶ are each independently H, halogen, C₁-C₆-alkyl, C₂-C₁₀-alkenyl or aryl or R⁵ and R⁶ may also be part of a ring system.

25. The process according to claim 22, wherein the epoxy compound (E) is a bisglycidyl ether based on bisphenols, in which the bisphenols are selected from the group of bisphenol A (CAS: 80-05-7), bisphenol AF (CAS: 1478-61-1), bisphenol AP (CAS: 1571-75-1), bisphenol B (CAS: 77-40-7), bisphenol BP (CAS: 1844-01-5), bisphenol C (CAS: 79-97-0), bisphenol C (CAS: 14868-03-2), bisphenol E (CAS: 2081-08-5), bisphenol F (CAS: 620-92-8), bisphenol FL (CAS: 3236-71-3), bisphenol G (CAS: 127-54-8), bisphenol M (CAS: 13595-25-0), bisphenol P (CAS: 2167-51-3), bisphenol PH (CAS: 24038-68-4), bisphenol S (CAS: 80-09-1), bisphenol TMC (CAS: 129188-99-4) and bisphenol Z (CAS: 843-55-0).

26. The process according to claim 22, wherein the epoxy compound (E) is selected from the group of tetraglycidylmethylenedianiline (TGMDA), epoxy novolaks and cycloaliphatic epoxy compounds.

27. The process according to claim 22, wherein the hardener (H) is selected from the group consisting of 1,3-diaminobenzene, 2,6-bis(aminomethyl)-piperidine, diethylenetriamine, triethylenetetramine, 4,4′-diaminodiphenyl sulfone, phthalic anhydride and hexahydrophthalic anhydride.

28. The process according to claim 16, wherein in process step a) a reinforcing material is additionally provided in the mold before the thermoset resin system is provided.

29. The process according to claim 28, wherein the thermoplastic polymer is applied to the reinforcing material.

30. A method for increasing the toughness of a thermoset molding which comprises utilizing a thermoplastic polymer having a porosity of 10% to 90%.
